(19) United States
(12) Patent Application Publication
(10) Pub. No.: US 2011/0216738 A1
(43) Pub. Date: Sep. 8, 2011

(54) Method and System for Mobile Station Acquisition

(75) Inventor: Phillip Barber, McKinney, TX (US)

(73) Assignee: FutureWei Technologies, Inc., Plano, TX (US)

(21) Appl. No.: 13/008,729

(22) Filed: Jan. 18, 2011

Related U.S. Application Data
(60) Provisional application No. 61/311,142, filed on Mar. 5, 2010.

(51) Int. Cl. H04W 36/38; H04W 72/04; H04W 88/02

(52) U.S. Cl. 370/331; 370/328; 370/329

(57) ABSTRACT

A system and method for mobile station acquisition are presented. A preferred embodiment comprises a control message that contains additional information than would be found in a neighbor advertisement MAC management message. This control message contains enough information to allow the mobile station to locate, synchronize, and acquire service from a separate base station for a handoff process.

This application claims the benefit of U.S. Provisional Application No. 61/311,142, filed on Mar. 5, 2010, entitled “Method and Application in Mobile Cellular Networks for Mobile Station Location, Synchronization, and Service Acquisition of Nearby Base Stations for Scanning and Handover Operations,” which application is hereby incorporated herein by reference.

### TECHNICAL FIELD

The present invention relates generally to a system and method for wireless communication and, more particularly, to a system and method for a mobile station acquisition in a wireless network.

### BACKGROUND

Generally, base stations may provide information to mobile stations in a wireless network through a periodic broadcast message such as a neighbor advertisement MAC management message (NBR-ADV). The NBR-ADV from one base station may provide the identity, operating characteristics, and methods to locate, synchronize, and acquire service for another nearby base station that may also serve as the mobile station's link to the mobile network. As such, the mobile station can use the information to locate, synchronize, and acquire service with a nearby base station through, e.g., a handoff process.

However, the information provided by the NBR-ADV is limited and does not provide all of the information that the mobile station may need for a handoff. Nor may all nearby base stations be included in the NBR-ADV message. The base station that is currently servicing the mobile station may frequently make control requests and demands of the mobile station to scan and evaluate the air link quality of nearby base stations before directing the mobile station to transition its point of attachment to the network through a handoff to a targeted nearby base station. Alternatively, the mobile station may not have received the NBR-ADV or may not have had time to process the NBR-ADV before the mobile station is directed to perform a scanning or handoff process. Because of this, the MS will not have the location, synchronization, and service acquisition information with a nearby base station and will have to rely upon the less efficient scanning process, which scanning results in increased power consumption on the mobile station and also imposes lengthy delay in scanning and handover processing that has a direct negative affect on the quality of service of the mobile station and on the network as a whole.

### SUMMARY OF THE INVENTION

These and other problems are generally solved or circumvented, and technical advantages are generally achieved, by preferred embodiments of the present invention which provide for a control message.

In accordance with a preferred embodiment of the present invention, a method for wirelessly transmitting data comprises transmitting a neighbor advertisement MAC management message from a first base station, the neighbor advertisement MAC management message comprising a first set of information. A control message is transmitted from the first base station, the control message comprising a second set of information in addition to the first set of information, the second set of information comprising information on a second base station.

In accordance with another preferred embodiment of the present invention, a method for wirelessly transmitting data comprises receiving a neighbor advertisement MAC management message at a mobile station. A control message is received at the mobile station, the control message comprising handoff information in addition to the information included in the neighbor advertisement MAC management message.

In accordance with yet another preferred embodiment of the present invention, a wireless base station comprises a processor configured to prepare a neighbor advertisement MAC management message and a control message, the control message comprising handoff information that is not included in the neighbor advertisement MAC management message. A transmitter is configured to receive the control message and transmit the control message.

In accordance with yet another preferred embodiment of the present invention, a wireless mobile station comprises a receiver configured to receive a neighbor advertisement MAC management message and a control message, wherein the neighbor advertisement MAC management message comprises a first set of information, wherein the control message comprises a second set of information, and wherein the second set of information comprises handoff information different from the first set of information. A transmitter is configured to transmit a handoff request in response to receiving the control message.

An advantage of a preferred embodiment of the present invention is that the control message allows a mobile station to bypass scanning nearby base stations. By bypassing the scanning, power, time, and resources are reduced, thereby making both the mobile station and the overall wireless system more efficient.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a first base station, a second base station, and a mobile station providing voice, data and/or other wireless communication services in accordance with an embodiment of the present invention;

FIG. 2 illustrates the transmission of information after a handoff routine has occurred in accordance with an embodiment of the present invention; and

FIG. 3 illustrates a structural diagram of the base station and the mobile station in accordance with an embodiment of the present invention

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a wireless network communication system. The invention may also be applied, however, to other communication systems.

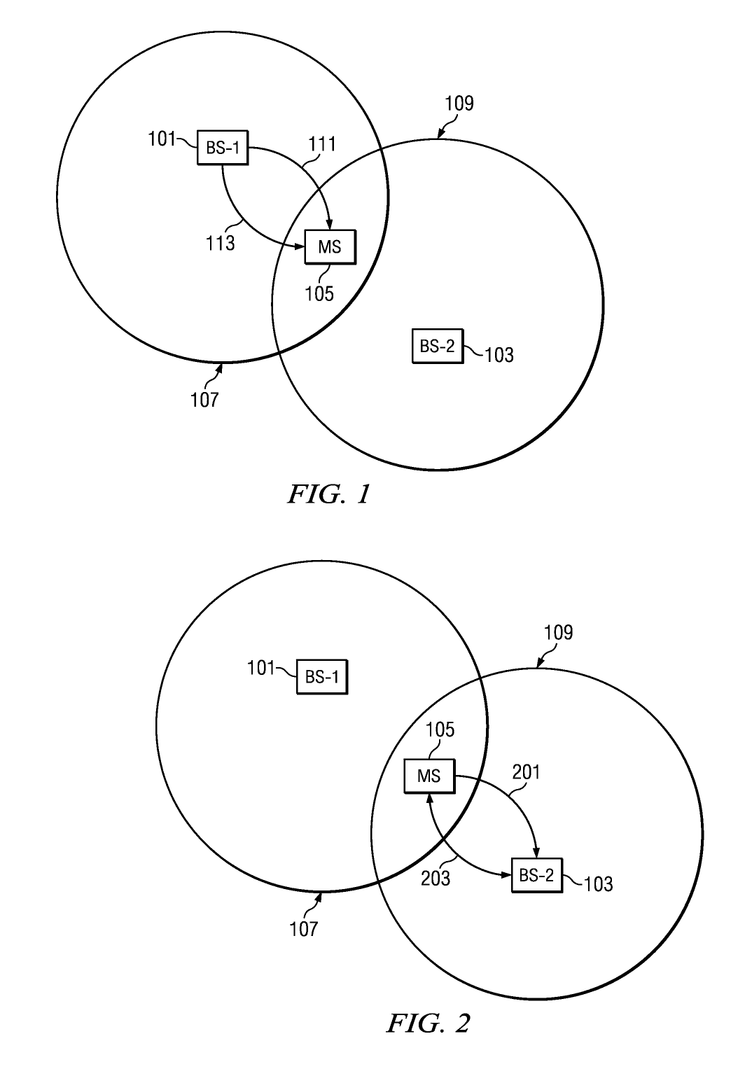

With reference now to FIG. 1, there is shown a first base station (BS-1) 101, a second base station (BS-2) 103, and a mobile station (MS) 105 providing voice, data and/or other wireless communication services. The BS-1 101, which may also be referred to by other names such as access network (AN), access point (AP), Node-B, etc., preferably transmits downlink (DL) information to the MS 105 while also receiving uplink (UL) information from the MS 105.

The BS-1 101 preferably has a corresponding first coverage area 107. This first coverage area 107 generally represents the range of the BS-1 101 to adequately transmit data to the MS 105 while also being able to adequately receive data transmitted from the MS 105. Further, while the first coverage area 107 is shown as a definitive line in FIG. 1 for convenience, one of ordinary skill in the art will realize that the first coverage area 107 varies depending upon a number of factors including the MS 105, the power of the BS-1 101, local terrain, intervening buildings, and the like.

Preferably, the wireless communications network includes, but is not limited to, an orthogonal frequency division multiple access (OFDMA) network such as an Evolved Universal Terrestrial Radio Access (E-UTRA) network, an Ultra Mobile Broadband (UMB) network, or an IEEE 802.16 network. However, as one of ordinary skill in the art will recognize, the listed networks are merely illustrative and are not meant to be exclusive. Any suitable multiple access scheme network, such as a frequency division multiplex access (FDMA) network wherein time-frequency resources are divided into frequency intervals over a certain time interval, a time division multiplex access (TDMA) network wherein time-frequency resources are divided into time intervals over a certain frequency interval, a code division multiplex access (CDMA) network wherein resources are divided into orthogonal or pseudo-orthogonal codes over a certain time-frequency interval, or the like may alternatively be used.

The MS 105 may comprise any device that desires to communicate, either directly or indirectly, with the BS-1 101. The MS 105 may include mobile phones, personal data assistants (PDAs), notebook computers, other computers that have a wireless connection with the BS-1 101, or the like, and any suitable device that may be used to transfer data between itself and the BS-1 101 (through, e.g., a transceiver) may be used as the MS 105.

The MS 105 preferably utilizes release 10 of the 3GPP wireless communication specification (3GPP Rel-10) or later versions of the 3GPP wireless communication specification. However, the present embodiments are not limited to only this wireless communication specification. For example, the Worldwide Interoperability for Microwave Access (WiMAX), Evolution-Data Optimized EV-DO, or Universal Mobile Telecommunications System (UMTS) communication standards may alternatively be utilized. These standards and all other suitable standards are fully intended to be included within the scope of the present embodiments.

The BS-2 103 may be similar to the BS-1 101. For example, the BS-2 103 may be referred to by other names such as access network (AN), access point (AP), Node-B, and may have a corresponding second coverage area 109. Similar to the first coverage area 107, the second coverage area 109 represents a range within which the BS-2 103 can adequately transmit data to the MS 105 while also being able to adequately receive transmissions from the MS 105. Additionally, as shown in FIG. 1, the first coverage area 107 and the second coverage area 109 may have some overlap in order to accommodate handoffs of the MS 105 from, e.g., the BS-1 101 to the BS-2 103.

FIG. 1 additionally illustrates the transmission of a Neighbor Advertisement MAC Management message (NBR-ADV) 111 from the BS-1 101 and receiving the NBR-ADV 111 at the MS 105. In an embodiment the NBR-ADV 111 may be a message that is sent periodically from the BS-1 101 to the MS 105 that identifies the identities, operating characteristics, and methods for the location, synchronization, and service acquisition of nearby base stations such as the BS-2 103. As such, the NBR-ADV 111 may include information such as the center frequency, bandwidth, and name of nearby base stations.

However, the NBR-ADV 111 does not include the information of every base station available for communication with the MS 105. Additionally, even if each available base station is included, the NBR-ADV 111 does not contain all of the information that may be used to initiate a handoff procedure (e.g., synchronization and service acquisition information) without first requiring the MS 105 to perform a scan of nearby base stations. Finally, even if the information of every base station has been included within the NBR-ADV, the MS 105 may not have successfully received or processed the NBR-ADV.

Accordingly, the BS-1 101 may transmit a control message 113 from the BS-1 101 to the MS 105. In an embodiment, the control message 113 may be a scanning and handover control message which may provide information and instructions to the MS 105 regarding nearby base stations such as BS-2 103 to which the MS 105 may be handed off. For example, the BS-1 101 may transmit a request that the MS 105 perform a scan in order to get air link quality assessments for potential target base stations, such as BS-2 103. Depending upon the results of the requested scan sent from the MS 105 back to the BS-1 101, the BS-1 101 may elect to send another message to the MS 105 and request that the MS 105 handover to the target base station such as BS-2 103. Alternatively, if the BS-1 101 does not need the results of the scan, the BS-1 101 may request that the MS 105 handover to the target base station such as BS-2 103 without first requesting a scan. Any suitable combination of messages may be utilized for the scanning and handover control message.

By transmitting the control message 113 from the BS-1 101 and receiving the control message 113 at the MS 105, the BS-1 101 may provide a handoff directive and enough information that would allow the MS 105 to perform a handoff from the BS-1 101 to the BS-2 103. By providing the information for the handoff, the control message 113 allows the MS 105 to bypass the lengthy, time consuming, and power consuming scanning to locate BS-2 103 because of incomplete information either left out of the NBR-ADV, not received by the MS 105, or else not processed by the MS 105.

For example, the control message 113 may include information that would allow the MS 105 to locate, synchronize, and acquire service from a nearby base station (e.g., BS-2 103). Such information may include a specific enumeration and identification of the identities, operating characteristics and methods of the BS-2 103. For example, the control message 113 may include parameters such as the BS-2's unique Base Station Identifier (BS ID), which may also include the BS-2's 103 Operator ID. Additionally, the control message 113 may include the center frequency of the BS-2 103 (in units of, e.g., Hz), the channel bandwidth (in units of Hz, such as 1.25 MHz, 5 MHz, 8.75 MHz, 10 MHz, and the like) of the BS-2 103. Also, the control message 113 may include a technology specific preamble index for the BS-2 103, such as a preamble index from the 3GPP standard, a preamble index from the 802.16 standard, a preamble index from 3GPP2 standard, or the like. Finally, the control message 113 may include a frequency allocation (FA) index. All of this information, some subcombination of this information, or the like may be included in the control message 113 in order to allow the MS 105 to bypass the scanning that would otherwise be necessary.

Additionally, the control message 113 may also include information that, while not directly related to location, may be useful for synchronization and service acquisition. Such information may include DCD Configuration Change Count, Downlink_Burst_Profile, BS EIRP, TTG, RTG, EIRxPIRmax, BS Restart Count, UL Configuration Change Count, Uplink_Burst_Profile, Contention-based reservation timeout, Ranging Backoff Start, Ranging Backoff End, Request Backoff Start, Request Backoff End, HO_ranging_start, HO_ranging_end, Periodic ranging backoff start, Periodic ranging backoff end, Initial ranging codes, Periodic ranging codes, Bandwidth request codes, Handover Ranging Codes, Start of ranging codes group, Permutation base, HARQ ACK delay for DL burst, Size of CQICH_ID field, Normalized C/N override, Initial ranging interval, Tx Power Report, Relative_Power_Offset_For_UL_HARQ_burst, UL_initial_transmit_timing, Fast Feedback Region, HARQ Ack Region, and Ranging Region/MS. By including some of this information, all of this information or some subcombination of this information within the control message 113 provides for a substantial reduction in a time delay of synchronization, service acquisition, handover reentry at the BS-2 103, and availability for control and data communications between the MS 105 and the BS-2 103.

FIG. 2 illustrates communications between the MS 105 and the BS-2 103 after the MS 105 has received the control message 113 and has initiated a handoff from the BS-1 101 to the BS-2 103. By receiving the control message 113 with the BS-2's 103 specific identification, the MS 105 can bypass scanning the base stations to locate a base station that can accept a handoff from the BS-1 101 and the MS 105 can progress straight to a handoff from the BS-1 101 to the BS-2 103. By bypassing the scanning, time and resources for both the MS 105 itself as well as the network 100 as a whole, may be minimized, thereby increasing the overall efficiency of the MS 105 and the network 100.

Once the control message 113 has been received by the MS 105 and the scanning has been bypassed, the MS 105 may send a handoff request 201 to the BS-2 103. Once the BS-2 has accepted the MS 105, the BS-2 103 and the MS 105 may begin to transmit UP information and DL information (as indicated on FIG. 2 by the double arrow line 203).

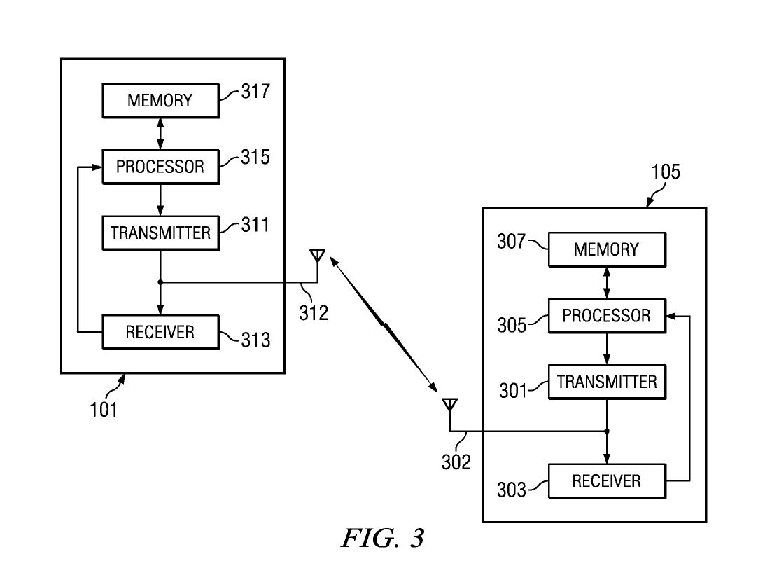

FIG. 3 shows a structural diagram of one embodiment of the BS-1 101 and the MS 105. The MS 105 may include a first transmitter 301 configured to transmit messages (not explicitly shown in FIG. 3) through a first antenna 302. The MS 105 may also include a first receiver 303 that is configured to receive transmissions such as the control message 113 and forward them to a first processor 305. The first processor 305, along with an associated first memory 307 may be used to process and/or store information received from the receiver (e.g., the control message 113) and prepare a response to the information received, such as determining the contents of, e.g., the control message 113 and an appropriate response, such as initiating the handoff. Additionally, the first processor 305 may prepare and forward a message, such as initiating the handoff from the BS-1 101 to the BS-2 103 to the first transmitter 301 for transmission through the first antenna 302.

The first transmitter 301, the first receiver 303, the first processor 305 and the first memory 307 may all be physically separate structures as illustrated in FIG. 3. Alternatively, however, some or all of these structures may be consolidated onto a single chip in order to conserve space and other resources. Any combination of integrated and separate components may utilized to realize the first transmitter 301, the first receiver 303, the first processor 305 and the first memory 307.

The BS-1 101 may contain a second receiver 313 in order to receive, e.g., transmissions from the MS 105. The second receiver 313 may forward the transmissions to the second processor 315 and its associated second memory 317, which may analyze the transmissions and determine an appropriate message for response, if desired. Alternatively, the second processor 315 may initiate a message, such as the control message 113. Once an appropriate message has been determined, the second processor 315 may forward the message, such as the control message 113 to the second transmitter 311 to transmit the control message 113 to the MS 105 through a second antenna 312.

Similar to the MS 105, the second transmitter 311, the second receiver 313, the second processor 315, and the second memory 317 may all be physically separate components of the BS-1 101 as illustrated in FIG. 3. Alternatively, however, some or all of these structures may be consolidated onto a single chip in order to conserve space and other resources. Any combination of integrated and separate components may utilized to realize the second transmitter 311, the second receiver 313, the second processor 315, and the second memory 317.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. As another example, it will be readily understood by those skilled in the art that the precise information within the control message may be varied while remaining within the scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for wirelessly transmitting data, the method comprising:
transmitting a neighbor advertisement MAC management message from a first base station, the neighbor advertisement MAC management message comprising a first set of information; and
transmitting a control message from the first base station, the control message comprising a second set of information in addition to the first set of information, the second set of information comprising information on a second base station.

2. The method of claim 1, wherein the second set of information further comprises an identity and operating characteristic of the second base station.

3. The method of claim 2, wherein the second set of information further comprises an identifier of the second base station, the central frequency of the second base station, and the channel bandwidth of the second base station.

4. The method of claim 2, wherein the second set of information further comprises a preamble index and a frequency allocation index.

5. The method of claim 1, wherein the control message further comprises a handoff directive.

6. A method for wirelessly transmitting data, the method comprising:
receiving a neighbor advertisement MAC management message at a mobile station; and
receiving a control message at the mobile station, the control message comprising handoff information in addition to the information included in the neighbor advertisement MAC management message.

7. The method of claim 6, wherein the control message is a scanning and/or handover control message.

8. The method of claim 6, wherein the control message comprises location, synchronization, and service acquisition information for a first base station.

9. The method of claim 8, wherein the control message comprises an identifier of the first base station, the central frequency of the first base station, and the channel bandwidth of the first base station.

10. The method of claim 8, wherein the control message further comprises a preamble index and a frequency allocation index of the first base station.

11. The method of claim 8, wherein the control message is received from a second base station different from the first base station.

12. The method of claim 6, further comprising performing a handoff after receiving the control message.

13. A wireless base station comprising:
a processor configured to prepare a neighbor advertisement MAC management message and a control message, the control message comprising handoff information that is not included in the neighbor advertisement MAC management message; and
a transmitter configured to receive the control message and transmit the control message.

14. The wireless base station of claim 13, wherein the control message further comprises an identity of a second wireless base station and an operating characteristic of the second wireless base station.

15. The wireless base station of claim 14, wherein the control message further comprises an identifier of the second wireless base station, a central frequency of the second wireless base station, and a channel bandwidth of the second wireless base station.

16. The wireless base station of claim 13, wherein the control message further comprises a preamble index of the second wireless base station and a frequency allocation index of the second wireless base station.

17. A wireless mobile station comprising:
a receiver configured to receive a neighbor advertisement MAC management message and a control message, wherein the neighbor advertisement MAC management message comprises a first set of information, wherein the control message comprises a second set of information, and wherein the second set of information comprises handoff information different from the first set of information; and
a transmitter configured to transmit a handoff request in response to receiving the control message.

18. The wireless mobile station of claim 17, wherein the control message further comprises an identity of a second wireless base station and an operating characteristic of the second wireless base station.

19. The wireless mobile station of claim 18, wherein the control message further comprises an identifier of the second wireless base station, a central frequency of the second wireless base station, and a channel bandwidth of the second wireless base station.

20. The wireless mobile station of claim 18, wherein the control message further comprises a preamble index of the second wireless base station and a frequency allocation index of the second wireless base station.
